(19) United States
(12) Patent Application Publication
(10) Pub. No.: US 2010/0044919 A1
(43) Pub. Date: Feb. 25, 2010

(54) MOLDING APPARATUS WITH DEFORMABLE MOLD

(76) Inventor: Horacio CORREIA, Terrebonne (CA)

Correspondence Address: LADAS & PARRY LLP, 224 SOUTH MICHIGAN AVENUE, SUITE 1600, CHICAGO, IL, 60604, US

(21) Appl. No.: 12/544,845

(22) Filed: Aug. 20, 2009

Related U.S. Application Data
(60) Provisional application No. 61/136,227, filed on Aug. 20, 2008.

(51) Int. Cl. B28B 7/06; B29C 39/06

(52) U.S. Cl. 264/313; 425/115; 425/253

(57) ABSTRACT

An apparatus for molding an article such as pre-cast, cement or concrete blocks, bricks, pavers, tiles and the like including a deformable mold and a movement imparting device. The deformable mold includes compartments or cavities for receiving material therein that is to be molded. Once the material has solidified so as to produce articles, the movement imparting device causes the deformable mold to curve thereby providing for the compartments to disengage from the solidified articles

### CROSS-REFERENCE TO RELATED APPLICATIONS

The present Application is based on U.S. Provisional Application No. 61/136,227 filed on Aug. 20, 2008 and incorporated herein in its entirety.

### FIELD OF THE INVENTION

The present invention relates to molding and de-molding articles such as pre-cast, cement or concrete blocks, bricks, pavers, tiles and the like. More specifically, but not exclusively the present invention relates to a molding apparatus with deformable mold.

### BACKGROUND OF THE INVENTION

There exists a variety of known devices for molding blocks such as pre-cast, cement, cementitious or concrete blocks, bricks, pavers, tiles and like articles. A challenge in the art is to de-mold these articles after curing. This challenge is due to the fact that removing the blocks from their mold is often difficult, requires elaborate, complex and expensive machinery that succumbs easily to wear and tear thereby raising costs and causes damage to or destruction of the molded articles. For example, many de-molding machines use reciprocating hammers which repeatedly hit the mold repeatedly until the blocks, pavers, tiles or like articles pop out of their mold compartments and are then removed by hand.

### OBJECTS OF THE INVENTION

An object of the invention is to provide an apparatus for molding and de-molding articles.

An object to the invention is to provide a molding assembly for articles.

An object of the invention is to provide a deformable mold.

An object of the invention is to provide a method for molding and de-molding articles.

### SUMMARY OF THE INVENTION

In accordance with an aspect of the present invention, there is provided an apparatus for molding an article comprising:

a deformable mold having at least one compartment to receive material that is to be molded therein so as to provide a solidified article; and

a movement imparting device for so curving the mold as to cause the compartment to disengage from the solidified article.

In accordance with an aspect of the present invention, there is provided a molding assembly comprising a plurality of the apparatuses as herein described.

In accordance with an aspect of the present invention, there is provided an apparatus for molding a cementitious block comprising:

a deformable mold having at least one compartment to receive cementitious material that is to be molded therein so as to provide a solidified cementitious block; and

a movement imparting device for so curving the mold as to cause the compartment to disengage from the solidified article.

In accordance with an aspect of the present invention, there is provided a mold for cementitious blocks comprising:

an elongated body made of flexible material and comprising a top side and an opposite rear side; and

a plurality of compartments formed in the top side for receiving material therein that is to be molded so as to provide solidified articles,

wherein the elongated body provides for being curved away from the solidified articles thereby disengaging the compartments therefrom.

In accordance with an aspect of the present invention, there is provided a method for molding an article comprising;

providing a deformable mold

adding material to be molded within the deformable mold;

allowing for the material to solidify; and

curving the deformable mold thereby disengaging the mold away from the solidified article.

Other objects, advantages and features of the present invention will become more apparent upon reading of the following non-restrictive description of illustrative embodiments thereof, given by way of example only with reference to the accompanying drawings.

### BRIEF DESCRIPTION OF THE FIGURES

In the appended drawings, where like reference numerals indicate like elements throughout and where:

FIG. 1 is a lateral schematic view of the molding apparatus in accordance with a non-restrictive illustrative embodiment of the present invention;

FIG. 2 is a top plan view of the apparatus of FIG. 1;

FIG. 3 is a lateral schematic view of the molding apparatus in accordance with another non-restrictive illustrative embodiment of the present invention; and

FIG. 4 is a top plan view of FIG. 3,

FIGS. 5, 6, and 7 are lateral sectional schematic views of the molding apparatus in accordance with a further non-restrictive illustrative embodiment of the present invention; and

FIG. 8 is a lateral schematic view of a molding assembly in accordance with a non-restrictive illustrative embodiment of the present invention.

### DETAILED DESCRIPTION OF THE ILLUSTRATIVE EMBODIMENTS

Generally stated, the present invention, in a non-restrictive illustrative embodiment thereof, relates to a molding apparatus comprising deformable mold having a plurality of compartments or cavities in its top side or face for receiving material therein that is to be molded thereby providing solidified articles. The mold is so deformable as to be curved when the material has solidified thereby disengaging or detaching the compartments from the solidified articles. A movement imparting device provides this curving movement of the deformable mold. In one example, the movement imparting device is a conveyor the mold is positioned face up on the conveyor and curved downwardly about a curved portion such as a roller thereby disengaging the mold from the articles. In another example, the mold is a conveyor belt mounted to rollers. In another example, the mold is placed facedown and curved upwardly by a top conveyor about a curved portion such as a roller.

With reference to the Figures non-limiting examples of the invention will now be described.

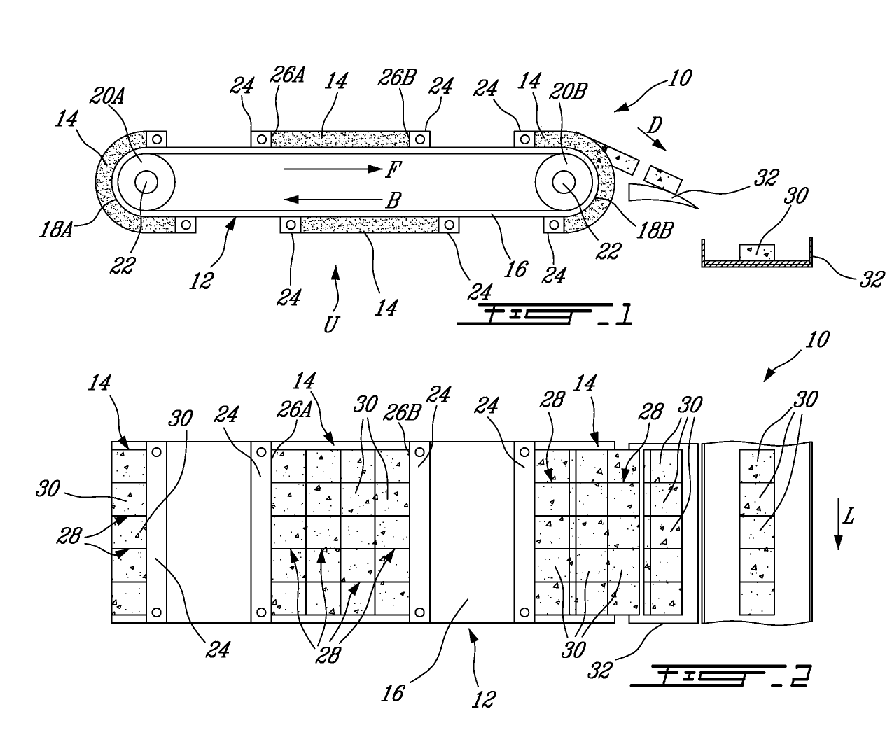

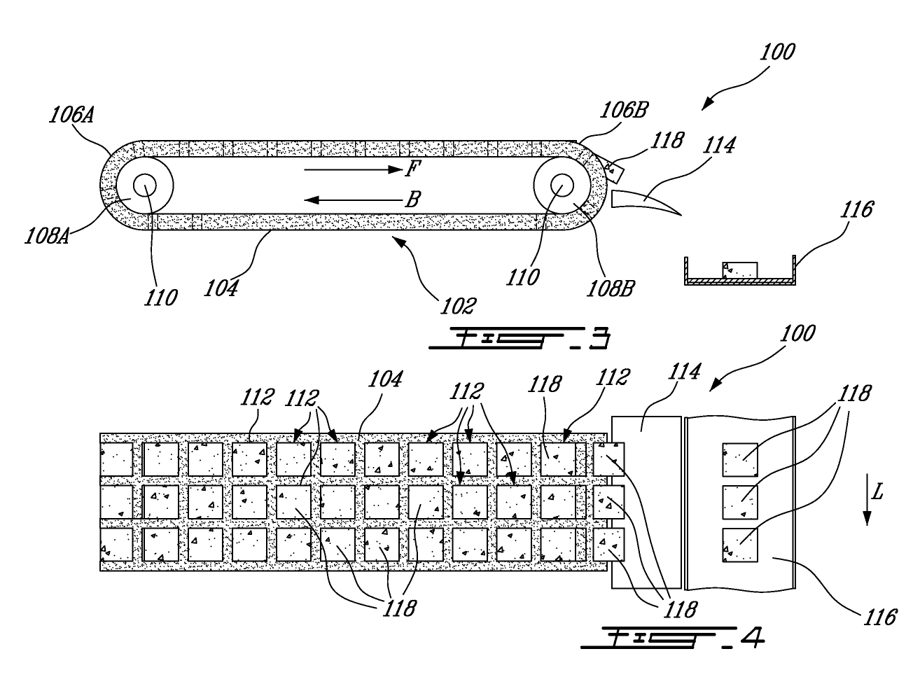

FIGS. 1 and 2 show a molding apparatus 10 including a movement imparting device such as conveyor 12 and deformable molds 14 mounted thereto in accordance with a non-restrictive illustrative embodiment of the present invention.

The conveyor 12 includes a conveyor belt 16 mounted at each end 18a and 18b thereof to a pair of rollers, 20a and 20b, respectively. At least one of the rollers 20a or 20b includes a central actuator 22 so as to cause rotation thereof, thereby consequently causing movement of the conveyor belt 16 as shown by arrows F and B.

The deformable molds 14 are made of flexible material such as polyurethane or any other suitable material and are removably fastened to the conveyor belt 16 via longitudinal brackets 24 at each end, 26a and 26b, thereof. Each mold 14 includes a plurality of molding compartments 28. In this case, molding compartments 28 are in the form of generally equal sized rectangular depressions or cavities within the mold 14 body. These molding compartments 28 are filed with material that is to be molded. In this non-limiting example, the molded articles are blocks or pavers 30 made of cementitious material, for example. Of course, other articles can be molded by the present device 10 such as a variety of pre-cast cementitious or concrete blocks, bricks, pavers, tiles and like articles as is known in the art.

A slide 32 is positioned adjacently to the conveyor 12 at side 18b thereof and leads toward an auxiliary platform 32 (which may also be a conveyor).

In operation, material is placed within the compartments 28 and given time for curing so as to form a molded and solidified article. In other examples, molding is achieved by allowing the material to dry, by compressing or by using a chemical agent which causes solidification of the material into a hardened article. The skilled artisan will readily appreciate that other such techniques known in the art can be contemplated within the scope of the present invention. Once the material within compartments 28 has been molded into finished articles, the conveyor 12 is moved forwardly, as shown by arrow F, towards side 18b. As the mold 14 reaches the area around roller 20b, it moves along with the belt 16 and curves about a curved portion in this case being roller 20b. The, foregoing causes each compartment 28 to disengage or detach itself from its respective finished article 30 which cannot be curved therewith and is instead de-molded therefrom continuing on its forward path and falling downwardly as shown by arrow D onto slide 32 which allows it to slide onto the platform 32 to be conveyed away as shown by arrow L. The mold 14 will be continually conveyed on the underside U of the conveyor 12 around and about roller 20a to be retuned to the top side T of the conveyor 12. The emptied mold 14 can have its compartments 28 refilled with a new material for further production of articles 30.

FIGS. 1 and 2 are schematic Figures and as such the conveyor 12 can be much longer to include a plurality of molds 14. Of course, a plurality of side by side conveyor belts 16 each having a plurality of molds 14 can also be contemplate within the scope of present invention. Schematic FIGS. 1 and 2 also represent the sequential movement of a single mold 14 on a given conveyor belts 16.

The user can remove a mold 14 by detaching the brackets 24 and place a different shaped mold made of similar material on the conveyor 12. These molds can also be removed in order to be filed with material at another station for example.

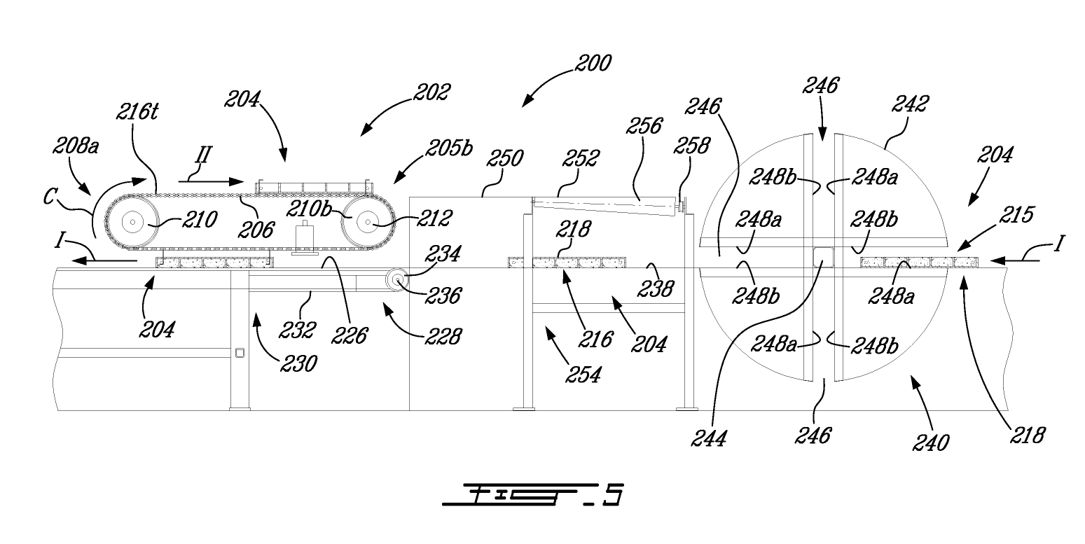

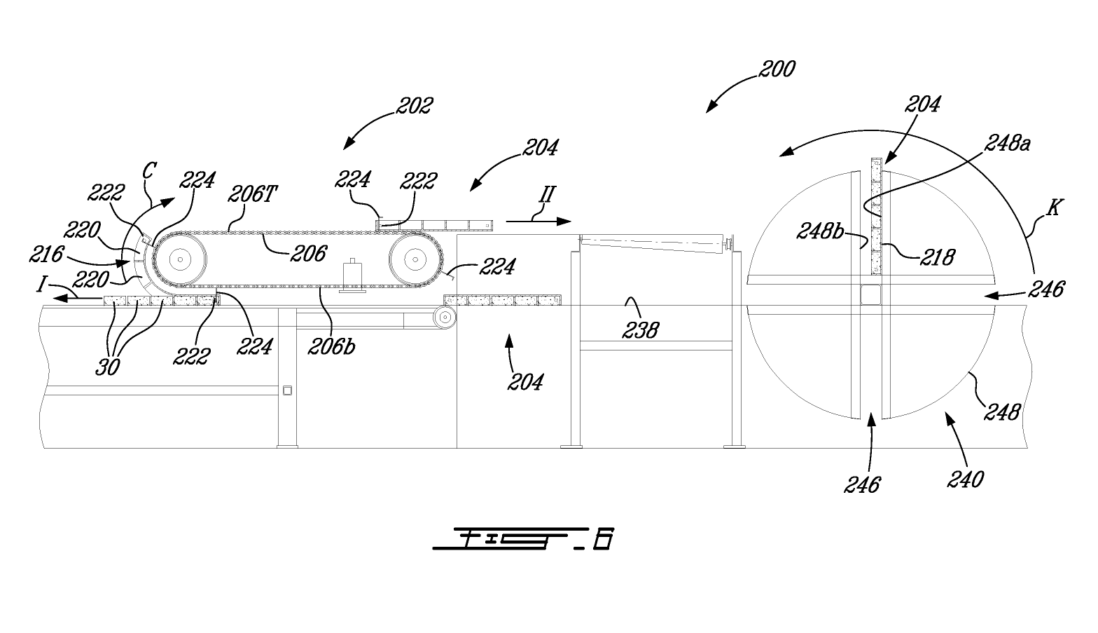

Turning to FIGS. 3 and 4 there is shown another non-restrictive illustrative embodiment of the present invention.

A molding apparatus 100 comprises a conveyor 102 including a conveyed belt 104 mounted at each end thereof, 106a and 106b, to respective rollers, 108a and 108b. As explained before the rollers 108a and 108b can be actuated by a central actuator 110 so as to cause the conveyor belt 104 to move in the direction shown by arrows F and B about the rollers 108a and 108b. The conveyor belt 104 is deformable and can be made of a flexible and resilient material and includes a plurality of molding compartments 112. Therefore the conveyor belt 104 is in essence a mold or conveyor mold or conveyor belt mold.

A slide 114 is positioned adjacently to the conveyor 102 at side 106b and leads toward an auxiliary platform 116, which can also be a conveyor.

In operation the user will fill the compartments 112 with a material that can be compressed to solidify, allowed time for curing, or made to solidify by a chemical agent or other techniques known in the art. Once the material has solidified it will produce articles 118 which are shown here to be in the form of pavers or blocks.

Once the articles 118 have solidified, the conveyor mold belt 104 is actuated in the direction shown by arrow F so as to curve and rotate about a curved portion in this case being roller 108b causing each compartment 112 to disengage or detach itself from the solidified article 118 which continues on its path onto slide 114 so as to fall on platform 116 to be conveyed elsewhere as shown by arrow L.

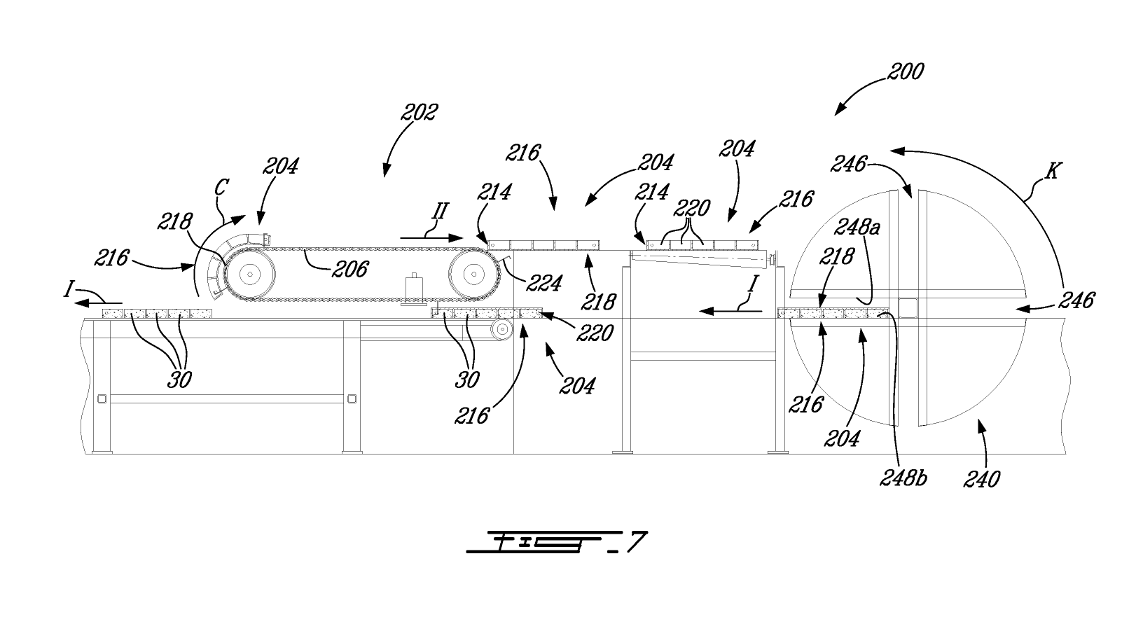

FIGS. 5 to 7 show a further non-restrictive illustrative embodiment of the present invention. The Figures show a molding apparatus 200 including a movement imparting device in the form of a conveyor 202 and deformable molds 204 mountable thereto.

With particular reference to FIG. 5, the conveyor 202 includes a conveyor belt 206 mounted at each end 208a and 208b thereof to a pair of rollers, 210a and 210b, respectively. At least one of the rollers 210a or 210b includes a central actuator 212 so as to cause rotation thereof in the clockwise direction C, thereby consequently causing movement of the conveyor belt 206 as shown by arrows I and II. As such, the conveyor belt 206 defines a top side 206T and a bottom side or underside 206B (see FIG. 6).

Turning particularly to FIG. 7 and as previously explained, the molds 204 comprise an elongated body 214 made of flexible material and including a top face or material-receiving side 216 and a rear closed side or underside 218. The material-receiving side 216 includes a plurality of molding compartments 220 to be filled with material that is to be molded in the shape of these molding compartments 220, such as articles 30 (cementitious blocks in this example) and a gen.

With particular reference to FIG. 6, the molds 204 and conveyor belt 206 include mutually engaging elements in the form of pins 222 laterally extending from the mold body 214 and hook elements 224 extending from the conveyor belt 206. As the belt 206 is conveyed, the hook elements 224 hook onto pins 222 thereby dragging the mold 204 therewith.

Turning to FIG. 5, the molding device 200 includes a platform 226 positioned underneath the conveyor 202. More specifically, the platform 226 is positioned beneath the conveyor belt bottom side 206B and spaced therefrom to allow a mold 204 therebetween.

The platform 226 is defined by conveyor 228 mounted to a support 230. The conveyor 228 includes a conveyor belt 232, defining the platform 226, and being mounted to rollers 234 (only one roller shown) powered by a central rotating actuator 236 to cause the belt 232 and thus the platform 226 to move in the direction shown by arrow I.

FIGS. 5 and 6 better shown an additional platform 238 is positioned between the platform 226 and a mold rotator 240. The additional platform 238 is contiguous with platform 226 and may comprise a variety of conveyor elements as the skilled artisan will readily appreciate to convey a mold 204 positioned thereon from the mold rotator 240 to the platform 226. The additional platform 238 can thus define an in-feed conveyor.

The mold rotator 240 comprises a rotatable body 242 powered by a rotating central actuator 244 to rotate in the counterclockwise direction K (see FIGS. 6 and 7). The rotatable body 242 includes radial slots 246 for receiving molds 204 therein. The slots 246 define spaced apart opposite platforms 248a and 248b for supporting the mold 204 thereon.

With particular reference to FIG. 5, the molding apparatus 200 includes a platform 250 adjacent the conveyor top side 206T. The platform 250 adjacent is an out feed conveyor 252 mounted to a support 254 and comprising a conveyor belt or carpet 256 powered by an actuator 258 for conveying molds 204 in a direction generally orthogonal arrows I and II.

In operation, material is placed in the compartments 220 with the mold 204 in the face-up position i.e. the position in which the material receiving side 16 is facing upwards and the opposite rear side 218 is on a platform.

When the material has been allowed sufficient time to solidify thus producing the solidified article 30, the mold 204 is inserted into slot 246 of the mold rotator 240 with the rear side 218 engaging the platform 248a. The rotating actuator 244 causes a counter-clockwise rotation K of the body 242 thereby causing the mold 214 to fall from the platform 248a onto the platform 248b in the facedown position i.e. the position in which its material receiving side to 16 engages a platform.

The mold 204 in the facedown position is conveyed from the rotator 240 to the platform 238.

The mold 204 in the facedown position is then conveyed from the platform 238 onto the platform 226 in the direction shown by 1, positioning the mold 204 beneath the conveyor belt bottom side 206B. In this way, as the conveyor belt 206 is moved in the clockwise direction, the hooking elements 224 extending therefrom engage the pins 220 extending from the mold 204 thereby conveying the mold therewith. At this stage the conveyor 228 may either stop to all the belt 206 to engage the mold 204 or the belt 206 is moved at a greater velocity than the conveyor 228.

The deformable mold 204 is curved upwardly about a curved section in the form of the roller 210a (see FIG. 6) thereby disengaging or detaching the compartments 220 from the articles 30 which are out-fed by platform 226 (see FIG. 7)

As shown in FIGS. 6 and 7, the emptied mold 204 is moved by the the conveyer belt 206 to top side 206T thereof in the face up position with its rear side 218 on the belt 206 and its material receiving side exposed. As the hook elements 214 are disengaged from the pins 222, the mold 204 is moved on platform 250 and then on platform 252 in the direction shown by arrow II to be conveyed therefrom and re-filled with material for molding more articles.

Therefore, the deformable, flexible and resilient molds described herein provide for removing solidified articles therefrom by curving it in the downward direction or in an upward direction about a curved portion such as a roller.

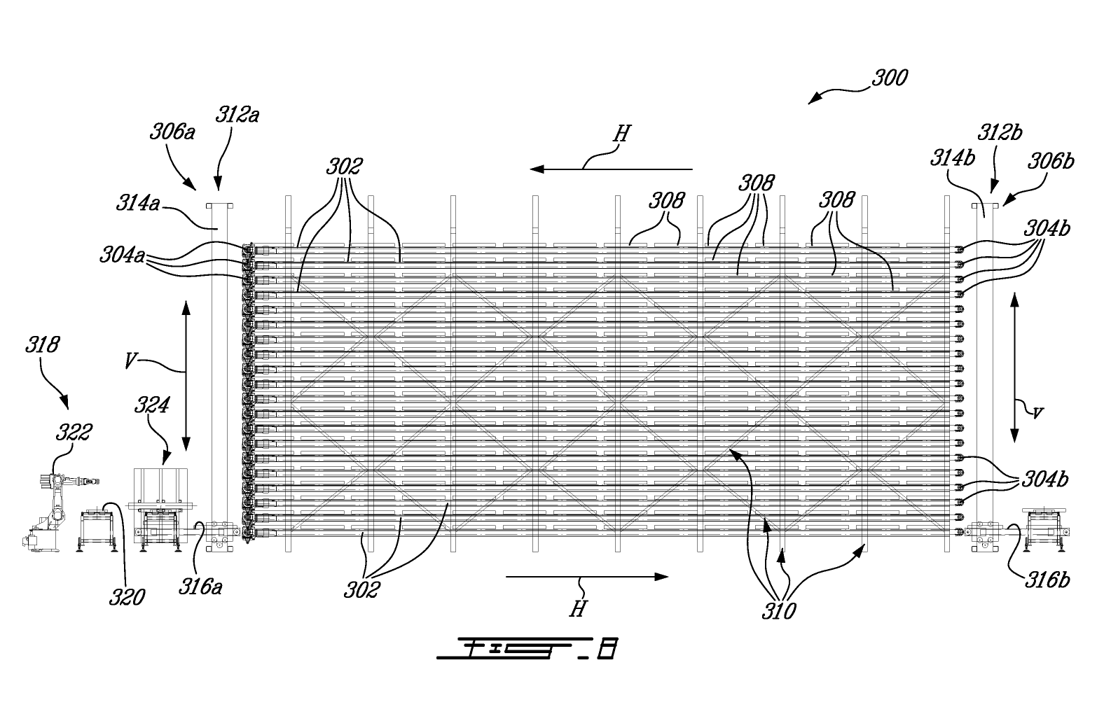

FIG. 8 shows a molding assembly 300 comprising a plurality of vertically stacked conveyers 302 having rollers 304a and 304b at each end 306a and 306b of the assembly 300, respectively. Deformable molds 308 are positioned on the conveyors for being horizontally conveyed between ends 306a and 306b (arrows H). The conveyors 302 are mounted to and stacked in a spaced manner on a support 310.

The assembly includes vertical conveyors 312a and 312b at each end 306a and 306b thereof. Each conveyor 312a and 312b includes vertical belt 314a and 314b respectively for conveying along a vertical axis (arrows V) a platform 316a and 316b.

The assembly 300 includes material filling station 318 including a platform 320 and a material dispensing device 322. The molds 308 are positioned face up on the platform 320 and their compartments are filled with material by the material dispensing device 322. The molds 202 are then pressed at a pressing station and placed onto platform 316a which brings the mold 308 onto a particular conveyor 302 and provide with time for curing in the face-up position.

Once the molds 302 have been allowed enough time for curing the vertically moveable platform 316a can retrieve the molds and turn them on the face-down position and reposition them on another of the horizontal conveyers 302. This other horizontal conveyer 302 is positioned directly beneath an upper horizontal conveyer 302 that engages the mold with its underside and coveys it about its roller 304b as explained above. The vertically moving platform 316b is positioned adjacent this roller 304b in order to retrieve the articles and place them on an out-feed platform 326.

As previously explained the emptied molds 308 are moved towards the upper side of the previously mentioned upper horizontal conveyor and the molds 302 are conveyed towards the assembly end 306a to be retrieved by the vertically movable platform 316a and re-filled.

Therefore, using a flexible mold having a plurality of compartments for molding articles provides for disengaging this mold from the articles during the molding by curving the flexible mold away from the articles.

In a non-restrictive illustrative embodiment of the present invention there is also provided a method for molding an article comprising adding material to be molded within a flexible mold providing for the material to be solidified and de-molding the solidified article by curving the flexible mold and therewith the compartment away the solidified article.

The various embodiments described herein and components and features thereof can be combined in various ways thereby providing other non-illustrated embodiments as will is understood by those having skill in the art.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

What is claimed is:

1. An apparatus for molding an article comprising:
a deformable mold having at least one compartment to receive material that is to be molded therein so as to provide a solidified article; and
a movement imparting device for so curving said mold as to cause said compartment to disengage from the solidified article.

2. An apparatus for molding an article according to claim 1, wherein said movement imparting device pulls said mold away from the solidified material during curving.

3. An apparatus according to claim 1, wherein said deformable mold comprises flexible material.

4. An apparatus according to claim 1, wherein said deformable mold comprises an elongated body with a plurality of said compartments, each compartment allowing for receiving material that is to be molded therein thereby providing a plurality of solidified articles.

5. An apparatus according to claim 4, wherein said plurality of compartments comprise respective generally rectangular articles thereby providing solidified articles in the form of blocks.

6. An apparatus according to clam 1, wherein said mold is curved upwards when disengaging said compartment from the solidified article.

7. An apparatus according to claim 1, wherein said mold is curved downwards when disengaging said compartment from the solidified article.

8. An apparatus according to claim 1, wherein said movement imparting device comprises a conveyor surface.

9. An apparatus according to claim 8, wherein said mold is mounted on said conveyor surface for being conveyed thereby, said mold comprising a material receiving side comprising said at least one compartment and an opposite rear side positioned on said conveyor surface.

10. An apparatus according to claim 9, wherein said movement imparting device comprises a curved portion thereof, said mold being curved when conveyed about said curved portion thereby disengaging said compartment from the solidified article.

11. An apparatus according to claim 8, wherein said conveyor surface comprises a conveyor belt mounted on a pair of opposite rollers, said mold being mounted on said conveyor belt for being conveyed thereby, said mold comprising a material receiving side comprising said at least one compartment and an opposite rear side positioned on said conveyor belt, said mold being curved when conveyed about a given said roller thereby disengaging said compartment from the solidified article.

12. An apparatus according to claim 1, wherein said mold comprises a conveyor belt, said movement imparting device comprising an actuator for conveying said conveyor belt mold and a curved portion, said actuator conveying said conveyor belt mold about said curved portion thereby disengaging said compartment from the solidified article.

13. An apparatus according to claim 12, wherein said conveyor belt mold is mounted on a pair of opposite rollers, said conveyor belt mold having a material receiving side comprising said at least one compartment and an opposite rear side positioned about said rollers, said conveyor belt mold being curved when conveyed about a given said roller thereby disengaging said compartment from the solidified article.

14. An apparatus according to claim 1, wherein said mold comprises a top material receiving side comprising said at least one compartment and an opposite rear side, said mold being positioned on a platform facedown with its material receiving side on said platform.

15. An apparatus according to claim 14, wherein said movement imparting device comprises a curved portion and provides for moving said mold about said curved portion thereby curving said mold and disengaging said compartment from the solidified article.

16. An apparatus according to claim 15, wherein said movement imparting device and said mold comprise mutually engaging elements thereby providing for said mold to be moved by said movement imparting device.

17. An apparatus according to claim 15, movement imparting device is positioned above said mold.

18. An apparatus according to claim 14, wherein said movement imparting device comprises a conveyor belt mounted to a pair of rollers, said conveyor belt being positioned above said mold, said conveyor belt and said mold comprising mutually engaging members providing for conveying said mold with said belt, said mold being curved when conveyed about a given said roller thereby disengaging said compartment from the solidified article.

19. A molding assembly comprising a plurality of the apparatuses of claim 1.

20. An apparatus for molding a cementitious block comprising:
a deformable mold having at least one compartment to receive cementitious material that is to be molded therein so as to provide a solidified cementitious block; and
a movement imparting device for so curving said mold as to cause said compartment to disengage from the solidified article.

21. A mold for cementitious blocks comprising:
an elongated body made of flexible material and comprising a top side and an opposite rear side; and
a plurality of compartments formed in said top side for receiving material therein that is to be molded so as to provide solidified articles,
wherein said elongated body provides for being curved away from the solidified articles thereby disengaging said compartments therefrom.

22. A method for molding an article comprising;
providing a deformable mold
adding material to be molded within the deformable mold;
allowing for the material to solidify; and
curving the deformable mold thereby disengaging the mold away from the solidified article.
